(19) United States
(12) Patent Application Publication
(10) Pub. No.: US 2023/0249208 A1
(43) Pub. Date: Aug. 10, 2023

(54) SPRAYING SYSTEM WITH SENSOR AIR SHIELD

(71) Applicant: Spraying Systems Co., Wheaton, IL (US)

(72) Inventor: Aaron Jordan, Gilberts, IL (US)

(21) Appl. No.: 18/106,250

(22) Filed: Feb. 6, 2023

Related U.S. Application Data
(60) Provisional application No. 63/307,394, filed on Feb. 7, 2022.

(51) Int. Cl. B05B 12/18; B05B 12/12

(52) U.S. Cl. CPC B05B 12/18; B05B 12/122

(57) ABSTRACT

A sensor air shield assembly includes a housing having a sensor mount. A sensor is supported on the sensor mount. The sensor has a lens. An air inlet is provided on the housing. An air passage is provided in the housing in communication with the air inlet. A discharge orifice is provided in the housing and in communication with the air passage. The discharge orifice is arranged on the housing in proximity to the sensor lens and directed such that air exiting the discharge orifice passes across the lens of the sensor.

### BACKGROUND OF THE INVENTION

Spraying systems are utilized to discharge fluids onto target objects in a variety of applications. For instance, in food processing applications, spraying systems may include one or more spray devices that discharge ingredients or other coatings onto food objects. In such applications, continuously discharging process fluid from the spray devices can produce a significant amount of overspray that does not contact any target object. Such overspray can be costly and wasteful. In order to help reduce or substantially eliminate this overspray, it is desirable to trigger discharge of process fluid from the spray device only when an object is present in a target zone of the spray device. One way in which this can be accomplished is via optical sensors that detect when an object is present in the target zone and then produce a signal that is used to actuate the spray device. When the object leaves the target zone, the optical sensor can send a further signal to deactivate the spray device.

While the use of sensors may help reduce overspray, they can be difficult to implement in applications in which the sensors are mounted in close proximity to the respective spray devices. In particular, with such arrangements, discharge of the spray devices can produce a certain amount of blowback that produces a fine mist or cloud of process fluid around the sensors. Over time, the process fluid blowback can accumulate on the lens of one or more of the optical sensors. This accumulation can disrupt the sensors' ability to function properly.

### OBJECTS OF THE INVENTION

In view of the foregoing, a general object of the present invention is to provide a spraying system that includes a sensing system that reliably detects when an object to be sprayed is present in a target zone.

A related object of the present invention is to provide a spraying system of the foregoing type in which the sensing system is capable of operating in applications in which the spraying system produces significant process fluid blowback spray.

A further object of the present invention is to provide a spraying system of the foregoing type that includes a sensing system that can be readily adapted to a variety of different sensor types and mounting arrangements.

A further object of the present invention is to provide a spraying system that includes a sensing system that is relatively simple in design and inexpensive to manufacture.

Other objects and advantages of the invention will become apparent upon reading the following detailed description and upon reference to the drawings. The identified objects are not intended to limit the present invention.

### BRIEF DESCRIPTION OF THE SEVERAL VIEWS OF THE DRAWINGS

FIG. 1 is a perspective view of a spraying system including a plurality of spray nozzle assemblies each having an associated actuation sensor air shield assembly according to the teachings of the present invention.

FIG. 2 is a side elevation view of the spraying system of FIG. 1.

FIG. 3 is a side elevation view of one spray nozzle assembly and the associated actuation sensor air shield assembly of FIG. 1.

FIG. 4 is a side perspective view of the actuation sensor air shield assembly of FIG. 3

FIG. 5 is a partially exploded, perspective view of the spray nozzle assembly of and associated actuation sensor air shield assembly of FIG. 3 with the mounting mechanism removed from the sensor air shield assembly for ease of reference.

FIG. 6 is a side sectional view of the actuation sensor air shield assembly of FIG. 5.

FIG. 7 is a partially cut away, side elevation view of an alternative embodiment of an actuation sensor air shield assembly and sensor according to the teachings of the present invention.

FIG. 8 is a bottom view of the actuation sensor air shield assembly and sensor of FIG. 7 showing the housing in partial section.

FIG. 9 is a side perspective view of the actuation sensor air shield assembly of FIG. 7 with the sensor removed for ease of reference.

### DETAILED DESCRIPTION OF THE INVENTION

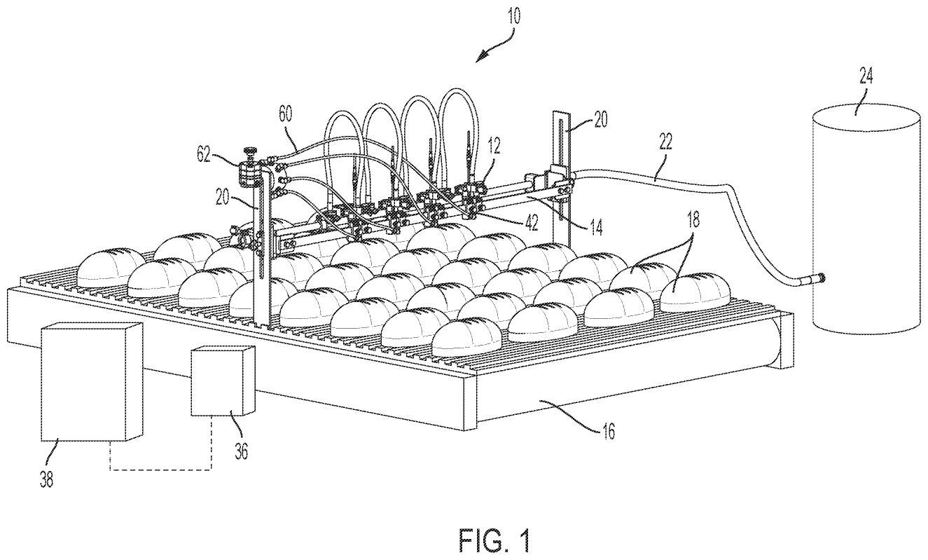

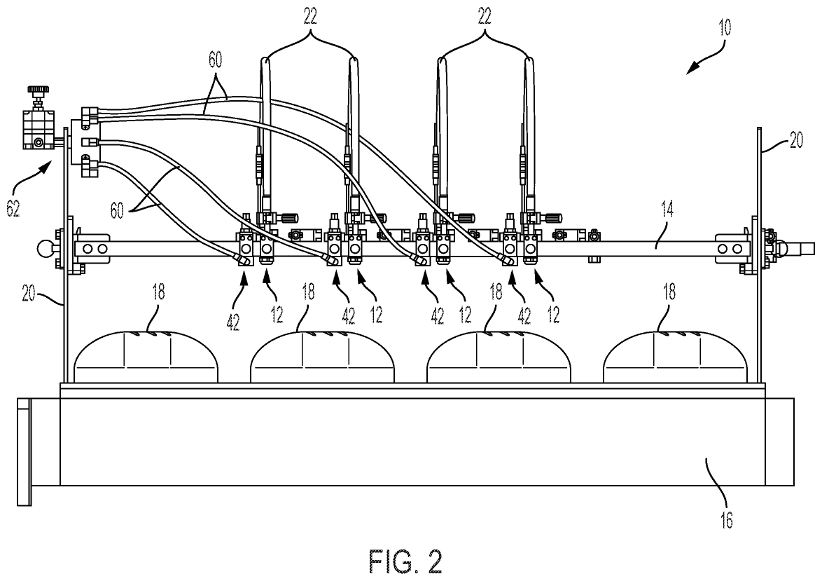

Referring to FIGS. 1 and 2 of the drawings, there is shown an exemplary embodiment of a spraying system 10 configured in accordance with the present invention. The illustrated spraying system 10 includes a plurality of spray nozzle assemblies 12 that are supported in laterally spaced relation along a header 14 that extends over a conveyor 16. The conveyor 16 may be used to transport a plurality of objects 18 to be sprayed. More specifically, the conveyor 16 transports objects 18 through a zone in which the spray nozzle assemblies 12 discharge a process fluid onto the objects 18. In one example, the objects 18 may be food items and the process fluid may be a coating that is applied to the food items. However, the present invention is not limited to the spraying of such liquids or use in such environments. Rather, the spraying system 10 of the present invention can be used with a wide variety of different spray targets and process fluids.

In this case, the header 14 is arranged transversely relative to the direction of travel of the conveyor 16 and is supported via upright members 20 arranged on opposing sides of the conveyor 16. The illustrated upright members 20 are configured such that the height of the header 14 relative to the conveyor 16 may be adjusted. In this way, the position of the spray nozzle assemblies 12 relative to the objects 18 to be sprayed may be adjusted as desired. The illustrated arrangement also includes four spray nozzle assemblies 12 on the header 14, although any number may be used. The spraying system 10 of the present invention is not limited to use with a header and conveyor arrangement such as shown in FIGS. 1 and 2. To the contrary, the spraying system 10 of the present invention may be used with any suitable apparatus for supporting the spray nozzle assemblies 12 in relation to the objects 18 to be sprayed and for delivering the objects to be sprayed to a target zone.

Each of the illustrated spray nozzle assemblies 12 is connected via a fluid supply line 22 to a process fluid storage and delivery unit 24 as shown in FIG. 1. The process fluid storage and delivery unit 24 may be configured to store and deliver pressurized process fluid to the individual spray nozzle assemblies 12 in a known manner. Any suitable apparatus for delivering process fluid to the spray nozzle assemblies 12 may be used.

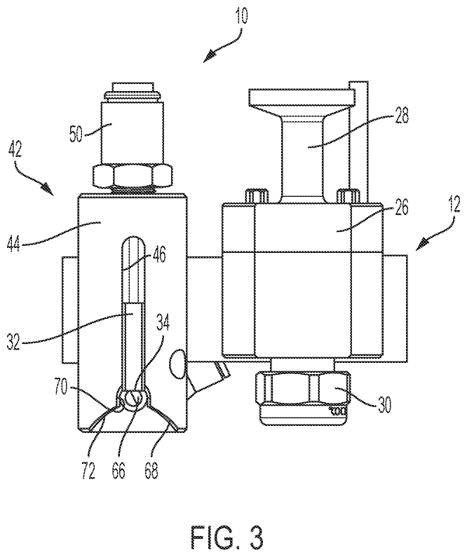

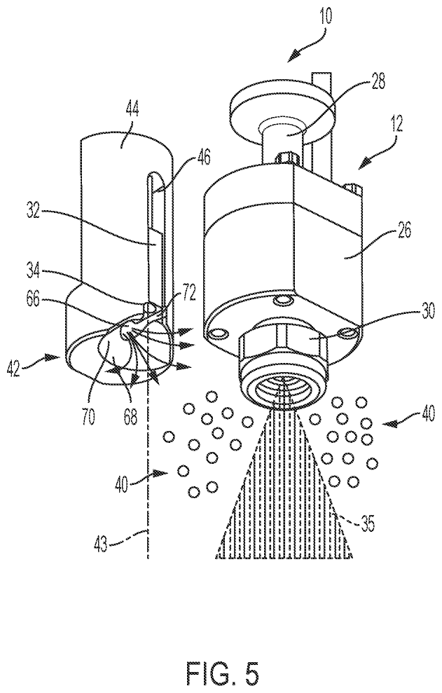

Each spray nozzle assembly 12 is generally configured to discharge process fluid supplied from the fluid discharge and delivery unit 24 upon actuation. In the illustrated embodiment as shown in FIGS. 3 and 5, each spray nozzle assembly 12 includes a nozzle body 26 having a fluid inlet 28 at one end that communicates with the process fluid supply line 22 and a nozzle tip 30 at the opposite end. The nozzle tip 30 is configured to define a nozzle opening through which the process fluid is discharged. Each spray nozzle assembly 12 and associated nozzle tip 30 may define a respective spray target zone into or onto which the process fluid is discharged (discharging process fluid is generally referenced as 35 in FIG. 5). The size and shape of this spray target zone will vary based on the configuration of the spray nozzle assembly 12 and nozzle tip 30. The spray nozzle assembly 12 and nozzle tip 30 may be configured to provide any desired spray pattern and, as will be appreciated from the following, the present invention is not limited to any particular spray nozzle assembly 12 or nozzle tip 30 configuration.

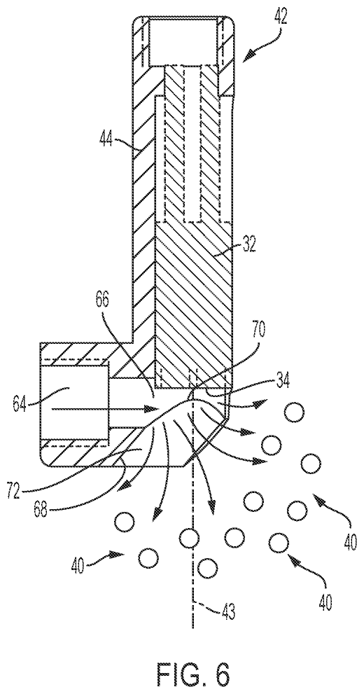

For determining when one or more objects 12 to be sprayed are in the target zone for a spray nozzle assembly 12, each spray nozzle assembly 12 may have an associated actuation sensor 32 as best shown in FIG. 2. The actuation sensor 32 may be an optical sensor that is disposed, oriented and configured to rapidly detect when an object 18 to be sprayed is present in the target zone of the associated spray nozzle assembly 12. To this end, the actuation sensor 32 may have at least one lens 34 or window (see FIGS. 5 and 6) for either emitting or detecting light. The light emitter may be, for example, a light emitting diode or a solid-state laser and the light detector may be a photo transistor. However, any type of optical sensor may be used including, for example, a laser sensor, photoelectric sensor or a color (e.g., RGB) detecting sensor.

For reducing wasteful overspray, each spray nozzle assembly 12 and associated actuation sensor 32 may be configured such that the spray nozzle assembly 12 is only actuated to discharge process fluid when an object 18 to be sprayed is detected in the target zone associated with the spray nozzle assembly. More specifically, the actuation sensor 32 may be configured to produce a detection signal when the object 18 to be sprayed is in the target zone and the associated spray nozzle assembly 12 may be configured to be actuated upon generation of the detection signal. In one embodiment, as shown in FIG. 1, the actuation sensors 32 communicate with a sensor controller 36 that, in turn, communicates with a spray controller 38 that directs various operational aspects of the spray nozzle assemblies 12. With this arrangement, when the spray controller 38 receives the detection signal via the sensor controller 36, the spray controller 38 directs actuation of the appropriate spray nozzle assembly 12. While the illustrated embodiment includes separate spray and sensor controllers, a single controller that incorporates both the sensing and spraying functions may be used. Additionally, the sensor and spray controllers 36, 38 could be configured to actuate the associated spray nozzle assembly to produce a single process fluid discharge or multiple process fluid discharge per detection signal. Additionally, deactivation of the appropriate spray nozzle assembly 12 may be based on a further signal from the actuation sensor 32 such as a signal indicating that the object 18 is no longer in the target zone or alternatively deactivation may be based on a timer.

To help ensure accurate detection, in the illustrated embodiment, the actuation sensor 32 is positioned in closed proximity to the associated spray nozzle assembly 12 as shown in FIGS. 2 and 3. Such positioning, however, can result in blowback spray 40 (see FIGS. 5 and 6) accumulating on the lens 34 of the actuation sensor 32 or otherwise obscuring the sensor's line of sight 43 (see FIGS. 5 and 6) to the target zone of the spray nozzle assembly 12. To help avoid this issue, a sensor air shield assembly 42 (shown in FIGS. 3-6) is provided that is configured to support the actuation sensor 32 and to direct a flow of pressurized air around the lens 34 of the actuation sensor 32 to shield against blowback process fluid spray 40 or other environmental substances interfering with the actuation sensor's ability to function properly. While the present invention has particular applicability to applications in which positioning the actuation sensor 32 in proximity to the spray nozzle assembly 12 is desirable, it may also be used in applications in which the actuation sensor 32 is positioned remotely from the spray nozzle assembly 12 yet is still susceptible to process spray or other environmental contaminants accumulating on or otherwise obscuring the lens 34 of the actuation sensor 32.

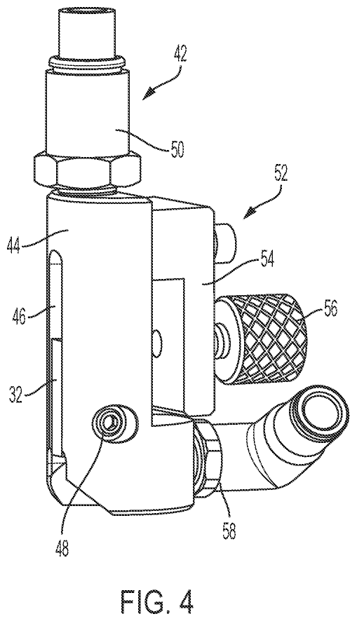

For supporting the actuation sensor 32 in an operational position relative to the spray nozzle assembly 12 and its associated target zone, the sensor air shield assembly 42 includes a housing 44 that defines a sensor mount, which in this case is a sensor receptacle 46 on or in which actuation sensor 32 may be supported. The sensor receptacle 46 is configured so that the actuation sensor 32 can be directed in a desired orientation relative to the target zone. In this case, as shown in FIGS. 3 and 5, the sensor receptacle 46 is configured such that the actuation sensor 32 remains centered in perpendicular relation to the target. In the illustrated embodiment, the housing 44 has an elongated configuration with the sensor receptacle 46 being defined by a channel in a side surface of the housing 44 that extends in the longitudinal direction with the actuation sensor 32 being arranged in the lower portion of the channel with the lens 34 (see FIG. 5) of the actuation sensor facing downward. To allow the lens 34 of the sensor to have a line of sight 43 to the corresponding target zone, the sensor receptacle 46 is open at its lower end as best shown in FIG. 5. The actuation sensor 32 may be secured in the sensor receptacle 46 via any suitable fastener such as for example a set screw 48 (see FIG. 4). The configuration of the sensor receptacle 46 may vary depending on the configuration of the actuation sensor 32 being used. In the illustrated embodiment, as shown in FIGS. 3 and 4, the housing 44 of the sensor air shield assembly 42 further includes an electrical connection 50 at its upper end to provide power to the actuation sensor 32 and to connect the actuation sensor 32 to the sensor controller 36.

For securing the sensor air shield assembly 42 to the header 14, the sensor air shield assembly 42 may include an adjustable mounting mechanism 52. As shown in FIG. 4, the illustrated mounting mechanism 52 includes an L-shaped bracket 54 secured to a rear surface of the sensor air shield housing 44. The L-shaped bracket 54 defines a slot within which the header 14, which in this case is configured as flat bar, can be captured. The illustrated mounting mechanism 52 has the advantage of allowing the lateral position of the sensor air shield assembly 42 on the header 14 to be adjusted as desired. A thumb screw 56 is provided to secure the sensor air shield assembly 42 in the desired position. Of course, other adjustable mounting mechanisms may be used depending on the particular configuration of the header 14 or other support arrangement for the sensor air shield assembly 42. Note that for ease of reference the mounting mechanism is not shown as part of the sensor air shield assembly in FIGS. 5 and 6.

To supply the necessary shield air, the sensor air shield assembly 42 includes an air inlet 58 located in this case near a lower end of the housing 44 that is connectable to an air supply line 60 as shown in FIG. 4. The air supply line 60, in turn, connects to a regulated air supply 62 that is configured to deliver pressurized air to the sensor air shield assembly 42. In the illustrated embodiment, as shown in FIGS. 1 and 2, the air supply 62 is arranged remotely from the sensor air shield assembly 42 on one of the upright members 20 supporting the header 14 and is configured to supply air to multiple sensor air shield assemblies 42 arranged on the header 14. In other embodiments, each sensor air shield assembly 42 may have its own air supply that is located adjacent to or integral with the sensor air shield assembly.

For directing the shield air toward the lens 34 of the actuation sensor 32, the sensor air shield assembly 42 includes a shield air discharge passage 64 that communicates with the air inlet 58. As best shown in FIG. 6, the shield air discharge passage 64 extends in a direction generally perpendicular to the line of sight 43 of the actuation sensor 32. Moreover, the shield air discharge passage 64 terminates in an air discharge orifice 66 that is located in proximity to the lens 34 of the actuation sensor 32, in this case to the side of the lens and spaced a distance in the direction of line of sight of the lens, so that air exiting the discharge orifice 66 passes across the lens of the sensor 32. The shield air discharge passage 64 has a cylindrical configuration so as to produce a consistent laminar flow of air across the surface of, and the area near the surface of, the lens 34 of the actuation sensor 32. In this context, laminar air flow refers to a constant stream of air that does not blend with other nearby layers. This laminar flow of shield air helps keep the lens 34 clear and dry of process fluid blowback 40 from the discharging spray nozzle assembly 12 as well as other contaminants. In the illustrated embodiment, the shield air discharge passage 64 has an upstream section with a relatively larger diameter and a downstream section with a relatively smaller diameter. This step down in diameter of the shield air discharge passage 64 serves to increase the pressure of shield air as it travels from the air inlet 58 to the air discharge orifice 66. The air pressure necessary to properly shield the lens 34 of the actuation sensor 32 is dependent on the droplet size of the blowback spray 40 or other contaminant present in a particular application. Accordingly, the pressure provided by the air supply 62 and/or the configuration of the shield air discharge passage 64 and air discharge orifice 66 may be adjusted as needed to match the particular droplet size found in an application.

For helping to shape the discharging shield air, the sensor air shield assembly 42 includes an air deflector surface 68 downstream of the air discharge orifice 66. The configuration of the air deflector surface 68 in the illustrated embodiment is best shown in FIGS. 3 and 5. The illustrated air deflector surface 68 includes an upper portion 70 adjacent the discharge orifice and a lower portion 72 below or downstream of the upper portion. The upper portion 70 includes sidewalls arranged near the outer lateral edges of the lens 34, while the lower portion 72 has a sidewall that tapers generally outward as the lower portion 72 extends downward and away from the upper portion 70 and the air discharge orifice 66. Depending on the particular application, the configuration of the deflector surface 68 may vary depending on the desired shield air flow characteristics. Moreover, the air deflector surface 68 is configured so as to ensure an unobstructed line of sight 43 for the actuation sensor 32. In the illustrated embodiment, the air deflector surface 68 provides a relatively wide opening around the lens 32 for operation of the actuation sensor 32. As will be appreciated, different actuation sensors 32 may have a line of sight 43 that extends at a different angle relative to the housing 44 and sensor receptacle 46, and the configuration of the air deflector surface 68 may be adjusted to accommodate the line of sight of the desired actuation sensor.

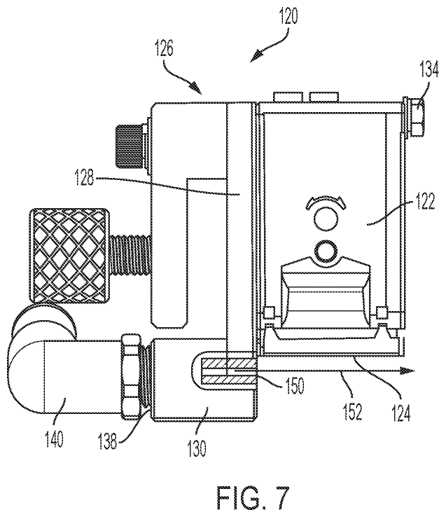

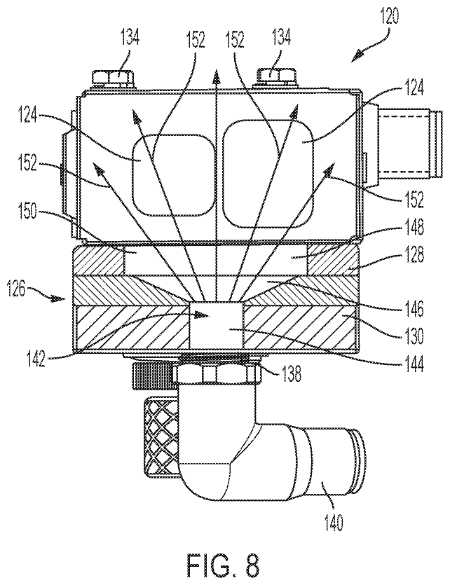

FIGS. 7-9 illustrate an alternative embodiment of a sensor air shield assembly 120 according to the present disclosure that can be used in conjunction with an actuation sensor 122 and one or more associated spray nozzle assemblies. For example, the associated spray nozzle assemblies may be configured such as shown in FIGS. 3 and 5. While configured somewhat differently, like the embodiment of FIGS. 3-6, the actuation sensor 122 of FIGS. 7 and 8 is an optical sensor having at least one lens 124 or window for either emitting or detecting light (see FIG. 8). As with the embodiment of FIGS. 3-6, the sensor air shield assembly 120 of FIGS. 7-9 is configured to support the actuation sensor 122 and to direct a flow of pressurized air across the lens 124 of the sensor to protect against blowback process fluid spray or other environmental substances accumulating on or otherwise obscuring the lens 124.

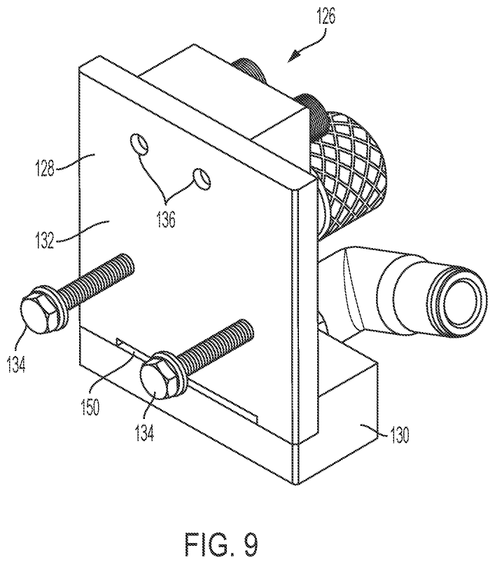

In the illustrated embodiment, the sensor air shield assembly 120 includes a housing 126 having an L-shaped configuration made up of first and second blocks 128, 130. More specifically, the housing 126 is configured to support the sensor 122 in a desired orientation such that it has a clear line of sight to the corresponding target zone. With reference to FIGS. 7 and 9, the first block 128 of the housing 126, in this case, defines a mounting surface 132 to which the sensor 122 can be secured. For example, in the illustrated embodiment the sensor 122 can be attached to the mounting surface 132 by removable fasteners, such as bolts 134, which are receivable in corresponding internally threaded openings 136 in the mounting surface 132 of the first block 128. Two pairs of threaded openings 136 are shown in the mounting surface 132 in FIG. 9, which allows for variability of the mounting arrangement based on the type of sensor being used. Additionally, for securing the sensor air shield assembly 120 to a header such as shown in FIGS. 1 and 2, the sensor housing 126 of FIGS. 7-9 uses the same adjustable mounting mechanism with L-shaped mounting bracket as shown in FIG. 4. The second block 130 of the housing 126 includes an air inlet 138 that is connectable to an air supply line 140.

For directing the shield air across the lens 124 of the sensor 122, the housing 126 includes a shield air discharge passage 142 that communicates with the air inlet 138 and terminates in an air discharge orifice 150. In this case, as shown in FIG. 8, the air discharge passage 142 includes first, second and third sections 144, 146, 148. The first section 144 of the air discharge passage 142 is furthest upstream (with reference to the air flow direction) and has a generally cylindrical configuration and communicates directly with the air inlet 138. The second section 146 is immediately downstream of the first section 144 and has a generally fan-shaped configuration that expands continuously outward as it extends in the downstream direction. The third section 148 of the air discharge passage 142 is immediately downstream of the second section 146 and, in the illustrated embodiment, is formed by a notch in a lower edge of the first block 128 and an upper surface of the second block 130 (see FIG. 9) which provides the third section with a rectangular cross-sectional configuration (see FIG. 8). As with the embodiment of FIGS. 3-6, the discharge passage 142 of the embodiment of FIGS. 7-9 is configured so as to produce a substantially consistent laminar flow of air to the discharge orifice 150.

The third section 148 of the air discharge passage 142 terminates at the discharge orifice 150 which is directed and arranged so as to produce a flow of air (referenced as 152 in FIGS. 7 and 8) across the lens of the sensor. To this end, like the embodiment of FIGS. 3-6, the discharge orifice 150 is positioned in proximity to the lens 124 of the sensor 122 as best shown in FIG. 7. More particularly, the discharge orifice 150 is positioned to the side of and spaced a distance along the line of sight from the lens 124 of the sensor 122. The illustrated discharge orifice 150 has a rectangular configuration (see FIG. 9) that together with the configuration of the discharge passage 142 produces a knife-like, fan-shaped flow of air across the lens 124 of the sensor 122 as shown in FIG. 8. However, it should be understood that other discharge orifice configurations could be used so long as a sufficient flow of air is produced across the lens of the sensor to prevent the lens from becoming obscured.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A spray assembly
a spray nozzle; and
a sensor air shield assembly comprising:
a housing having a sensor mount;
a sensor supported on the sensor mount, the sensor having a lens with a line of sight to a target zone of the spray nozzle assembly;
an air inlet provided on the housing that is connectable to a regulated pressurized air supply;
an air passage in the housing in communication with the air inlet; and
a discharge orifice in the housing and in communication with the air passage, the discharge orifice being arranged on the housing in proximity to the sensor lens and directed such that air exiting the discharge orifice passes across the lens of the sensor.

2. The spray assembly of claim 1 wherein the spray nozzle is actuated based on a signal generated by the sensor.

3. The spray assembly of claim 1 wherein the sensor is arranged in proximity to the spray nozzle.

4. The spray assembly of claim 1 wherein the air passage extends in perpendicular relation to the line of sight of the sensor.

5. The spray assembly of claim 1 wherein the air passage has a cylindrical section.

6. The spray assembly of claim 5 wherein the cylindrical section is a first section and the air passage further includes a second section downstream of the first section, the second section having a fan-shaped configuration that expands continuously outward as it extends in the downstream direction.

7. The spray assembly of claim 6 wherein the air passage further includes a third section downstream of the second section, the third section having a rectangular cross-sectional configuration.

8. The spray assembly of claim 7 wherein the discharge orifice has a rectangular configuration.

9. The spray assembly of claim 1 further including a deflector surface downstream of the discharge orifice.

10. The spray assembly of claim 1 wherein the sensor mount is a receptacle within which the sensor is received.

11. The spray assembly of claim 1 wherein the sensor mount is a mounting surface to which the sensor is mounted by removable fasteners.

12. A sensor air shield assembly comprising:
a housing having a sensor mount;
a sensor supported on the sensor mount, the sensor having a lens;
an air inlet provided on the housing;
an air passage in the housing in communication with the air inlet; and
a discharge orifice in the housing and in communication with the air passage, the discharge orifice being arranged on the housing in proximity to the sensor lens and directed such that air exiting the discharge orifice passes across the lens of the sensor.

13. The spray assembly of claim 12 wherein sensor has a line of sight and the air passage extends in perpendicular relation to the line of sight.

14. The spray assembly of claim 12 wherein the air passage has a cylindrical section.

15. The spray assembly of claim 14 wherein the cylindrical section is a first section and the air passage further includes a second section downstream of the first section, the second section having a fan-shaped configuration that expands continuously outward as it extends in the downstream direction and wherein the air passage further includes a third section downstream of the second section, the third section having a rectangular cross-sectional configuration.

16. The spray assembly of claim 16 wherein the discharge orifice has a rectangular configuration.

17. A sensor air shield assembly comprising:
a housing having a sensor mount for supporting a sensor;
an air inlet provided on the housing;
an air passage in the housing in communication with the air inlet; and
a discharge orifice in the housing and in communication with the air passage, the discharge orifice being arranged in proximity to the senor mount.

18. The spray assembly of claim 12 wherein the air passage has a cylindrical section.

19. The spray assembly of claim 14 wherein the cylindrical section is a first section and the air passage further includes a second section downstream of the first section, the second section having a fan-shaped configuration that expands continuously outward as it extends in the downstream direction and wherein the air passage further includes a third section downstream of the second section, the third section having a rectangular cross-sectional configuration.

20. The spray assembly of claim 16 wherein the discharge orifice has a rectangular configuration.
